(19) United States
(12) Patent Application Publication
(10) Pub. No.: US 2024/0386642 A1
(43) Pub. Date: Nov. 21, 2024

(54) IMAGE PROCESSING DEVICE, IMAGE PROCESSING METHOD, AND PROGRAM

(71) Applicant: Preferred Networks, Inc., Tokyo (JP)

(72) Inventors: Zhihao FANG, Tokyo (JP); Minjun LI, Tokyo (JP); Yanghua JIN, Tokyo (JP); Huachun ZHU, Tokyo (JP)

(21) Appl. No.: 18/785,692

(22) Filed: Jul. 26, 2024

Related U.S. Application Data
(63) Continuation of application No. PCT/JP2023/001190, filed on Jan. 17, 2023.

(30) Foreign Application Priority Data
Feb. 3, 2022 (JP) 2022-015798

(51) Int. Cl. G06T 11/60; G06T 5/50

(52) U.S. Cl. CPC G06T 11/60; G06T 5/50; G06T 2200/24; G06T 2207/20081; G06T 2207/20084; G06T 2207/20221

(57) ABSTRACT

An image processing device includes one or more storage devices; and one or more processors configured to create a first image by inputting a first latent variable into a first generative model; store the first latent variable in the one or more storage devices in association with identification information of the first generative model; acquire the first latent variable and the identification information of the first generative model associated with the first latent variable; generate a second latent variable based on the first latent variable; create a second image by inputting the second latent variable into the first generative model; and store the second latent variable in the one or more storage devices in association with the identification information of the first generative model. The second image is different from the first image and includes at least a second object different from a first object included in the first image.

### CROSS-REFERENCE TO RELATED APPLICATIONS

This application is a continuation application of International Application No. PCT/JP2023/001190 filed on Jan. 17, 2023, and designating the U.S., which is based upon and claims priority to Japanese Patent Application No. 2022-015798, filed on Feb. 3, 2022, the entire contents of which are incorporated herein by reference.

### BACKGROUND

### 1. Technical Field

The present disclosure relates to an image processing device, an image processing method, and a program.

### 2. Description of the Related Art

Techniques for performing various image processing by using deep learning have been realized. For example, image creation, image edit, fusion of multiple images, and the like are realized.

### RELATED ART DOCUMENT

### Patent Document

Patent Document 1: WO 2019/118990
Patent Document 2: Japanese Laid-Open Patent Application Publication No. 2021-86462

### SUMMARY

According to one embodiment of the present disclosure, an image processing device includes one or more storage devices; and one or more processors. The one or more processors are configured to create a first image by inputting a first latent variable into a first generative model; store the first latent variable in the one or more storage devices in association with identification information of the first generative model; acquire the first latent variable and the identification information of the first generative model associated with the first latent variable from the one or more storage devices; generate a second latent variable based on the first latent variable; create a second image by inputting the second latent variable into the first generative model; and store the second latent variable in the one or more storage devices in association with the identification information of the first generative model. The second image is different from the first image and includes at least a second object different from a first object included in the first image.

### BRIEF DESCRIPTION OF THE DRAWINGS

FIG. 1 is a diagram illustrating an example of a functional configuration of an image processing device;

FIG. 2 is a drawing illustrating an example of a process selection screen;

FIG. 3 is a drawing illustrating an example of the process selection screen;

FIG. 4 is a drawing illustrating an example of an image creation screen;

FIG. 5 is a drawing illustrating an example of the image creation screen;

FIG. 6 is a drawing illustrating an example of the image creation screen;

FIG. 7 is a drawing illustrating an example of the image creation screen;

FIG. 8 is a drawing illustrating an example of a save confirmation screen;

FIG. 9 is a drawing illustrating an example of an image fusion screen;

FIG. 10 is a drawing illustrating an example of an image selection screen;

FIG. 11 is a drawing illustrating an example of the image fusion screen;

FIG. 12 is a drawing illustrating an example of the image fusion screen;

FIG. 13 is a drawing illustrating an example of an attribute adjustment screen;

FIG. 14 is a drawing illustrating an example of the attribute adjustment screen;

FIG. 15 is a drawing illustrating an example of the attribute adjustment screen;

FIG. 16 is a drawing illustrating an example of a help screen;

FIG. 17 is a drawing illustrating an example of an image detail screen;

FIG. 18 is a flowchart illustrating an example of a processing procedure of an image processing method;

FIG. 19 is a flowchart illustrating an example of a processing procedure of image fusion processing; and

FIG. 20 is a diagram illustrating an example of a hardware configuration of an image creation device.

### DETAILED DESCRIPTION

In the following, embodiments of the present disclosure will be described with reference to the accompanying drawings. Here, in the specification and the drawings, components having substantially the same functional configuration are denoted by the same reference symbols, and duplicated description thereof will be omitted.

### [Outline of Image Processing Device]

An image processing device according to an embodiment of the present disclosure is an image processing device configured to provide an image processing tool in which various image processing is integrated. The image processing tool according to the present embodiment can perform, as image processing, image creation, attribute adjustment of an object included in the image, image editing, changing of the posture of an object included in the image, and fusion of multiple images.

In the present embodiment, the object included in the image is a character (a person). However, the object included in the image is not limited to this, and may be any object that can be represented by an image, such as an animal, a virtual creature, a robot, a landscape, or a building, for example. Additionally, the image may be represented in any form, such as an illustration style, a real image style, or computer graphics (CG), for example. Further, the image may be used for a moving image or an animation.

The image processing tool according to the present embodiment enables an image generated by certain image processing to be used in another image processing. For example, multiple images generated by image creation processing can be fused into one image by image fusion processing. Additionally, for example, an image generated by a method other than the image processing tool and an image generated by the image creation processing can be fused into one image by the image fusion processing. Additionally, for example, the image fusion processing can be performed on an image obtained by attribute adjustment processing, image edit processing, or posture change processing. Additionally, for example, the attribute adjustment processing, the image edit processing, the posture change processing, or the image fusion processing can be performed on a fused image generated by the image fusion processing.

The image processing tool according to the present embodiment can use multiple generative models corresponding to features of an image to be processed. Examples of the features of the image include a body part (for example, a face, an upper body, or a whole body), a gender, and clothes of a person included in the image. Other examples of the features of the image include the type of the object included in the image, the resolution of the image, and the touch of the image. However, the unit for preparing the generative model is not limited to these, and the generative model may be prepared according to other features.

The image processing tool according to the present embodiment realizes predetermined image processing by inputting, into a trained generative model or an edit model trained to correspond to the generative model, a latent variable corresponding to the generative model. Here, the “latent variable corresponding to the generative model” is, for example, a latent variable belonging to a latent space of the generative model or a latent variable associated with the generative model.

The latent variable is information necessary for generating an image by using the generative model, and may be sampled from a probability distribution followed by variables input into the generative model during training. Additionally, the latent variable may be latent information described in Patent Document 1. Additionally, the latent variable may be information including any of a code or attribute described in Patent Document 1. Additionally, the latent variable may be information input into a corresponding generative model and may include any information on noise, a gene, an attribute, or a posture.

The image processing tool according to the present embodiment can perform latent variable generation processing of generating a latent variable from an image. In the latent variable generation processing, for example, the image is input into an encoder model corresponding to the generative model, thereby generating a latent variable belonging to the latent space of the generative model. The encoder model may be a neural network trained for the generative model. As another example, the latent variable generation processing can generate a latent variable belonging to the latent space of the generative model by optimizing an initial latent variable by using the generative model. A method of specifying the initial latent variable may be a fixed value or a random value, but is not limited thereto. Additionally, the latent variable generated using the encoder model may be optimized using the generative model. However, the latent variable generation processing is not limited to these, and the latent variable belonging to the latent space of the generative model may be generated from the input image by any method.

In particular, in the image fusion processing, multiple images are fused using latent variables corresponding to the multiple images and belonging to the latent space of the same generative model. Thus, in the image fusion processing, when latent variables of multiple input images belong to latent spaces of different generative models, the image processing tool according to the present embodiment performs the latent variable generation processing on any of the images to generate a latent variable belonging to the latent space of the same generative model. Additionally, in the image fusion processing, the fusion processing may be performed using latent variables associated with the same generative model.

### [Functional Configuration of Image Processing Device]

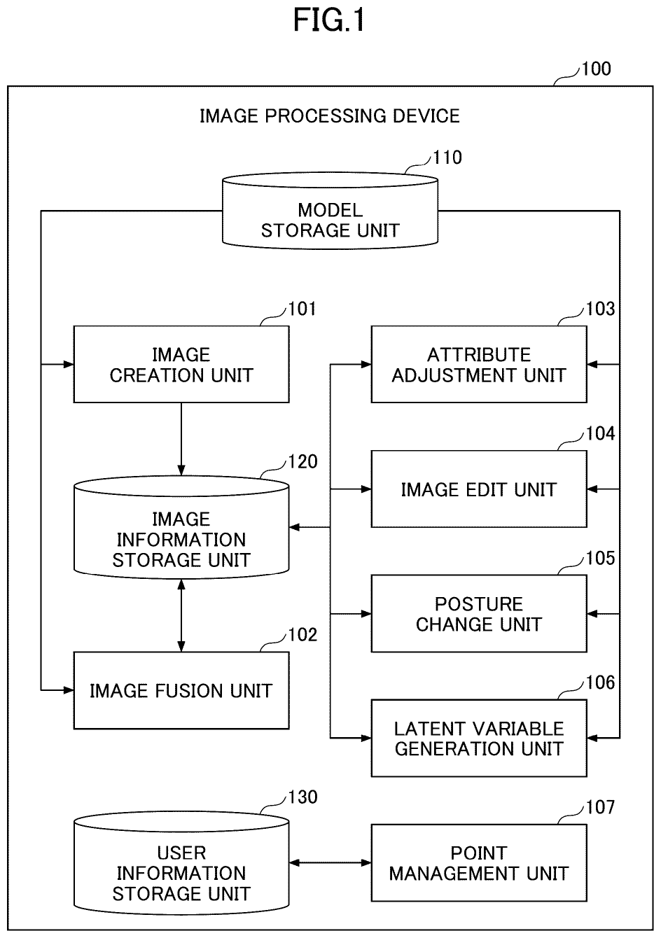

First, a functional configuration of an image processing device according to the embodiment of the present disclosure will be described with reference to FIG. 1. FIG. 1 is a block diagram illustrating an example of the functional configuration of the image processing device according to the present embodiment.

As illustrated in FIG. 1, an image processing device 100 according to the present embodiment includes an image creation unit 101, an image fusion unit 102, an attribute adjustment unit 103, an image edit unit 104, a posture change unit 105, a latent variable generation unit 106, a point management unit 107, a model storage unit 110, an image information storage unit 120, and a user information storage unit 130.

### <Model Storage Unit>

The model storage unit 110 stores one or more trained generative models. A structure of the generative model may be a neural network or a deep neural network. The structure of the generative model and a method of training the generative model are disclosed in Patent Document 1, for example.

Additionally, the model storage unit 110 stores a trained edit model and encoder model corresponding to the generative model. The edit model is disclosed in Patent Document 2, for example. A known method can be used as a method of training the encoder model.

### <Image Information Storage Unit>

The image information storage unit 120 stores an image, a latent variable of the image, and identification information (for example, a name of the generative model, an ID of the generative model, or the like) for identifying the generative model that has generated the image in association with each other. The image stored in the image information storage unit 120 may be an image generated by the image processing device 100 or an image generated by another method and uploaded to the image processing device 100.

### <User Information Storage Unit>

The user information storage unit 130 stores information about a user of the image processing tool. The user information in the present embodiment includes authentication information and contract information. The authentication information is information used for authenticating a user. An example of the authentication information is a user ID for identifying the user and a password set by the user. The contract information includes information indicating a fee plan contracted by the user and information indicating points possessed by the user.

### <Image Creation Unit>

The image creation unit 101 newly creates an image by using the generative model stored in the model storage unit 110. Specifically, first, the image creation unit 101 generates a latent variable as a random number.

Next, the image creation unit 101 creates the image by inputting the generated latent variable into the generative model. Then, the image creation unit 101 stores the created image in the image information storage unit 120 in association with the latent variable and the identification information of the generative model.

### <Image Fusion Unit>

The image fusion unit 102 fuses at least two images by using the generative model stored in the model storage unit 110. Specifically, the image fusion unit 102 first generates a fused latent variable by fusing a latent variable of a first image and a latent variable of a second image. Here, the fusion includes generating a new latent variable (fused latent variable) using both the latent variable of the first image and the latent variable of the second image. Additionally, the image fusion unit 102 may generate the fused latent variable by applying a predetermined operation to the latent variable of the first image and the latent variable of the second image. The predetermined operation may be a genetic operation, such as crossover, mutation, or selection on the latent variable, a predetermined composite operation, such as four arithmetic operations or a logical operation, or the like.

Next, the image fusion unit 102 creates a fused image by inputting the fused latent variable into the generative model. Then, the image fusion unit 102 stores the created fused image in the image information storage unit 120 in association with the fused latent variable and the identification information of the generative model.

Details of the method for fusing the images by using the generative model are disclosed in Patent Document 1, for example. Here, the image fusion unit 102 may create a fused image by fusing three or more images.

### <Attribute Adjustment Unit>

The attribute adjustment unit 103 adjusts the attribute of the object included in the image by using the generative model stored in the model storage unit 110. Specifically, the attribute adjustment unit 103 first receives an input of an attribute value in accordance with a user operation. The input attribute value may be an absolute value of the attribute or a relative value of the attribute of the image. Next, the attribute adjustment unit 103 converts the latent variable of the image in accordance with the received attribute value.

Examples of the attribute to be adjusted include shapes of ears, eyes, mouth, and the like, colors of skin, eyes, and the like, a hair style and a hair color, postures such as arm positions and poses, expressions such as joy, anger, sorrow, and pleasure, types, colors, shapes, and the like of clothes, accessories such as glasses and hats, and the like of a person. Here, the attributes of the object are not limited to these, and any item may be defined as an attribute as long as it is an item meaningful to the user in changing the image of the target object.

Subsequently, the attribute adjustment unit 103 creates an image whose attribute has been adjusted by inputting the converted latent variable into the generative model. Then, the attribute adjustment unit 103 stores the image whose attribute has been adjusted in the image information storage unit 120 in association with the converted latent variable and the identification information of the generative model.

Details of the method of adjusting the attribute of the image by using the generative model are disclosed in the following Reference Document 1, for example.

[Reference 1] Minjun Li, Yanghua Jin, Huachun Zhu, “Surrogate Gradient Field for Latent Space Manipulation,” arXiv: 2104.09065, 2021.

### <Image Edit Unit>

The image edit unit 104 edits the image by using the edit model stored in the model storage unit 110. Specifically, the image edit unit 104 predicts a segmentation map and a latent variable for each segment region from the image to be edited. Next, the image edit unit 104 changes either or both of the segmentation map and the latent variable for each segment region in accordance with a user operation.

Subsequently, the image edit unit 104 creates the edited image by inputting the changed segmentation map and latent variable into the edit model. The edit model may be a trained neural network. Then, the image edit unit 104 stores the edited image in the image information storage unit 120 in association with the segmentation map, the latent variable for each segment region, and the identification information of the edit model.

Here, the latent variable for each segment region used in the edit model and the latent variable used in the generative model are different from each other, but can be converted into each other. Therefore, when an image edited by the image edit processing is used in another image processing, it is only necessary to convert a latent variable for each segment region into a latent variable used in the generative model. Alternatively, a latent variable used in the generative model may be generated from the image edited in the image editing processing by the latent variable generation processing described below.

Details of a method of editing the image by using the edit model are disclosed in Patent Document 2, for example.

### <Posture Change Unit>

The posture change unit 105 changes a posture of the object included in the image by using the generative model stored in the model storage unit 110. Specifically, the posture change unit 105 first receives an input of posture information indicating a posture after the change in accordance with a user operation. Next, the posture change unit 105 converts the latent variable of the image in accordance with the received posture information.

Subsequently, the posture change unit 105 creates an image in which the posture has been changed by inputting the converted latent variable into the generative model. Then, the posture change unit 105 stores, in the image information storage unit 120, the image in which the posture has been changed, in association with the converted latent variable and the identification information of the generative model.

Here, the posture change unit 105 may predict the posture in the image to be changed before receiving the user input as a preparation step. This allows the user to easily designate the posture after the change.

Details of the method of changing the posture in the image by using the generative model are disclosed in Patent Document 1, for example.

### <Latent Variable Generation Unit>

The latent variable generation unit 106 generates the latent variable from the image by using the encoder model stored in the model storage unit 110. Specifically, the latent variable generation unit 106 predicts the latent variable of the generative model by inputting the image into the encoder model.

The latent variable generation unit 106 may generate the latent variable by optimizing the initial latent variable by using the generative model without using the encoder model. A method of designating the initial latent variable may be a fixed value or a random value, but is not limited thereto. Here, the latent variable generation unit 106 may optimize, by using the generative model, the latent variable predicted using the encoder model. This allows the latent variable to reflect the feature of the image more.

### <Point Management Unit>

The point management unit 107 manages points possessed by the user. The point management unit 107 subtracts (consumes) points in accordance with the image processing used by the user. At this time, the image creation processing, the image fusion processing, and the latent variable generation processing consume a first number of points, and the attribute adjustment processing, the image edit processing, and the posture change processing consume a second number of points that is less than the first number of points. That is, the point management unit 107 is configured to consume a larger number of points in the processing of newly creating an image (the image creation processing, the image fusion processing, and the latent variable generation processing) than in the processing of editing an existing image (the attribute adjustment processing, the image edit processing, and the posture change processing).

The image fusion processing is special processing of fusing multiple images selected by the user, the number of consumed points may be set to be greater than that in other image processing(s). That is, the point management unit 107 may consume, in the image fusion processing, a third number of points that is greater than the first number of points.

The point management unit 107 may consume no points when the attribute adjustment processing, the image edit processing, and the posture changing processing are performed (that is, the second number of points is 0), and may consume a fourth number of points less than the first number of points when the image created by these processing is stored. With this, the user can perform processing for editing an existing image without worrying about point consumption.

The classification of the image processing consuming the first number of points and the image processing consuming the second number of points is not limited to these, and can be suitably selected. For example, the first number of points may be consumed in the image fusion processing, and the second number of points less than the first number of points may be consumed in the image creation processing, the attribute adjustment processing, the image edit processing, the posture change processing, and the latent variable generation processing. At this time, the point management unit 107 may consume no points when the image creation processing, the attribute adjustment processing, the image edit processing, the posture change processing, and the latent variable generation processing are performed (that is, the second number of points is 0), and may consume a fifth number of points less than the first number of points when the image generated in these processing is stored.

The points possessed by the user are determined as follows. When the user newly makes a contract, points corresponding to a fee plan are given. As the fee plan, a free plan and a subscription plan are provided, and the subscription plan is charged. Even if the points are consumed, points are recovered after a predetermined time elapses. It is also possible to purchase chargeable additional points. The upper limit of the points that can be possessed by the user and the rate of point recovery vary depending on the fee plan.

The point management unit 107 consumes a large number of points in the processing of newly creating an image and consumes a small number of points in the processing of editing an existing image, and thus the following effects are expected.

First, the user needs to consume a large number of points to acquire the image (creation or fusion). However, once the image is acquired, the user can enjoy the change of the image by performing various editing operations with a small number of points. With respect to the above, there is a limit for the mode of changes in only editing the image, the user gradually wants a new image. In such a way, the user repeats the cycle of creating or fusing and editing the image.

That is, by providing a gradient to the number of points to be consumed in accordance with the type of the image processing as described above, the user's motivation to use the image processing tool can be increased. As a result, the user can be caused to consume more points.

### [User Interface of Image Processing Device]

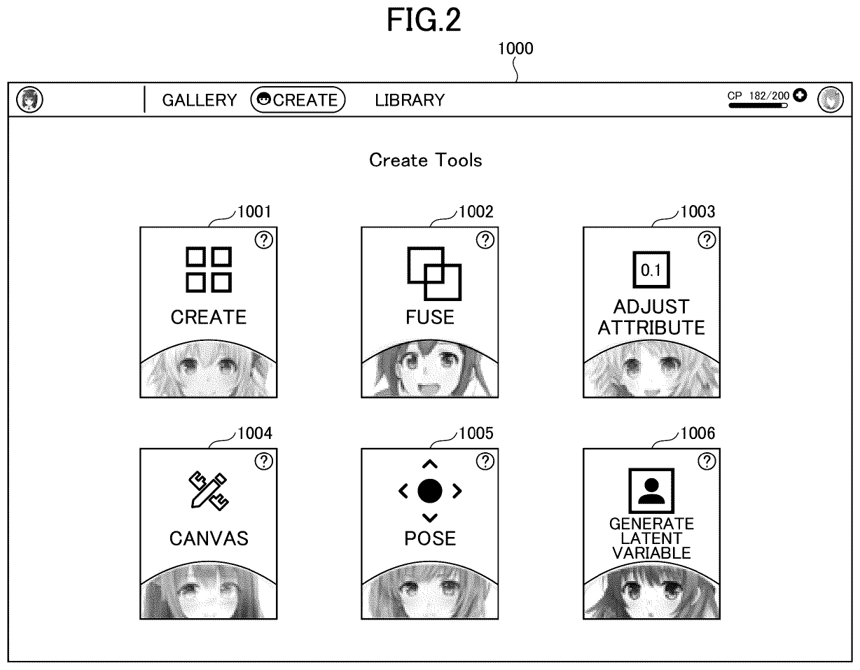

Next, a user interface of the image processing device according to the embodiment of the present disclosure will be described with reference to FIG. 2 to FIG. 29. The user interface may be realized as, for example, an operation screen provided to a user terminal by the image processing device 100.

FIG. 2 is a drawing illustrating an example of a process selection screen for selecting the image processing. As illustrated in FIG. 2, a process selection screen 1000 includes start buttons 1001 to 1006 corresponding to the respective image processing. When the user presses any of the start buttons 1001 to 1006, the image processing corresponding to the start button is performed. The number of the start buttons displayed on the process selection screen 1000 can be changed according to the type of image processing provided by the image processing tool.

In the example of FIG. 2, the start button 1001 (generation) starts the image creation unit 101 to perform the image creation processing. The start button 1002 (fusion) starts the image fusion unit 102 to perform the image fusion processing. The start button 1003 (attribute adjustment) starts the attribute adjustment unit 103 to perform the attribute adjustment processing. The start button 1004 (canvas) starts the image edit unit 104 to perform image edit processing. The start button 1005 (pose) starts the posture change unit 105 to perform the posture change processing. The start button 1006 (latent variable conversion) starts the latent variable generation unit 106 to perform the latent variable generation processing.

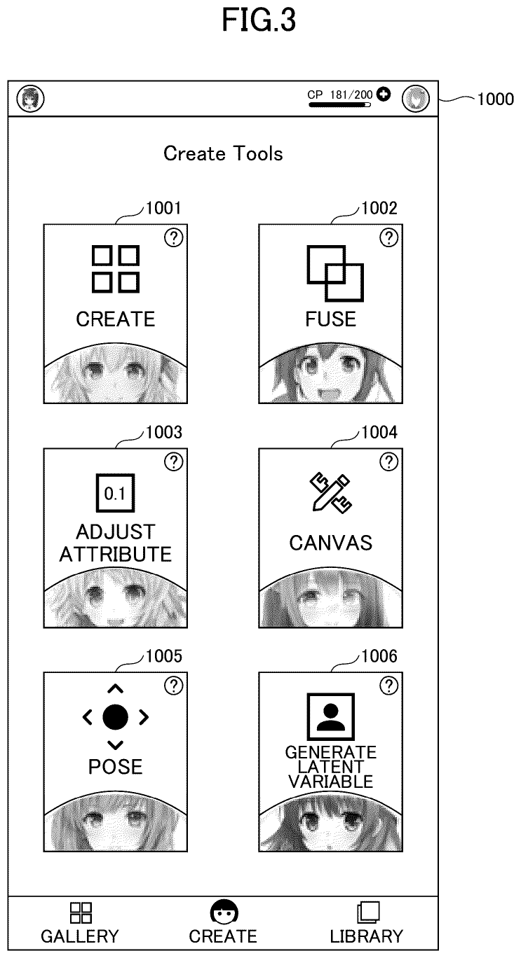

FIG. 3 is a drawing illustrating an example of a case where the shape of the process selection screen 1000 is changed to be vertically long. As illustrated in FIG. 3, when the shape of the entire process selection screen 1000 is changed, the control may be performed such that the arrangement of the start buttons is changed. At this time, preferably, the control is performed such that the start button 1001 corresponding to the image creation processing is always located at the upper left of the screen.

In the image processing tool according to the present embodiment, another image processing is often started, triggered by newly creating an image. Therefore, by performing the control such that the start button corresponding to the image creation processing is always located at the upper left of the screen where the user can easily recognize it as the processing to be performed first, a user interface that is easy for the user to operate intuitively can be realized.

Here, an authentication screen for authenticating the user may be displayed prior to the display of the process selection screen 1000. The authentication screen receives an input of authentication information, such as a user ID and a password in accordance with a user operation, and transmits the authentication information to the image processing device 100. The image processing device 100 performs authentication using the received authentication information based on the user information stored in the user information storage unit 130. When the authentication is successful, the image processing device 100 displays the process selection screen 1000 on the terminal of the user who has been successfully authenticated.

### <Image Creation Processing>

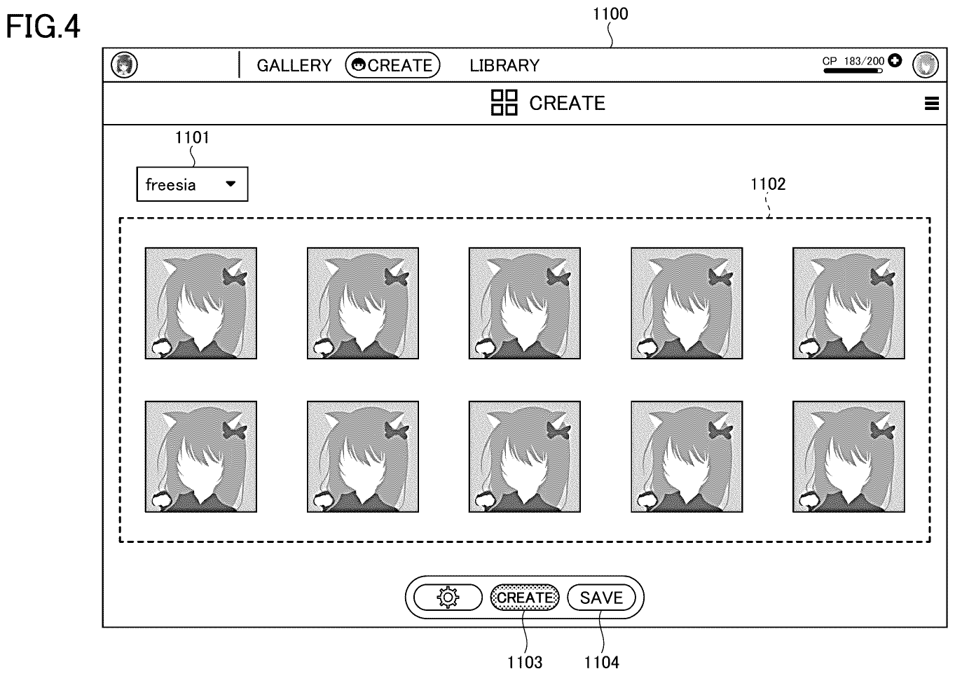

A user interface in the image creation processing will be described with reference to FIG. 4 to FIG. 8.

FIG. 4 is a drawing illustrating an example of an image creation screen for generating an image. As illustrated in FIG. 4, an image creation screen 1100 includes a model selection field 1101, an image selection area 1102, a creation button 1103, and a save button 1104. In the model selection field 1101, the names of the generative models stored in the model storage unit 110 are displayed such that the name of the generative model can be selected in a drop-down list. When the user selects the generative model in the model selection field 1101 and presses the creation button 1103, the image creation unit 101 newly generates an image by using the selected generative model.

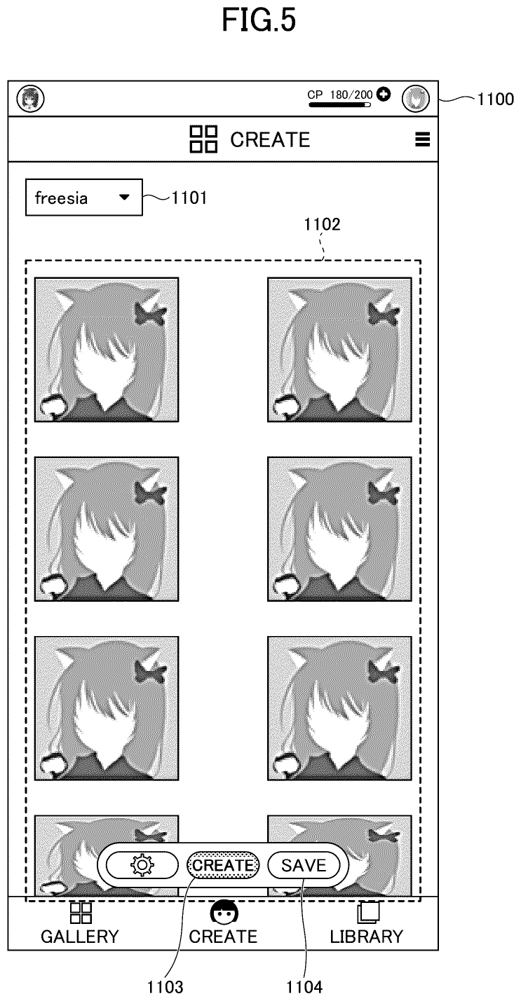

FIG. 5 is a drawing illustrating an example of a case where the shape of the image creation screen 1100 is changed to be vertically long. As illustrated in FIG. 5, when the shape of the entire image creation screen 1100 is changed, the control may be performed such that the arrangement of the image selection area 1102 is changed.

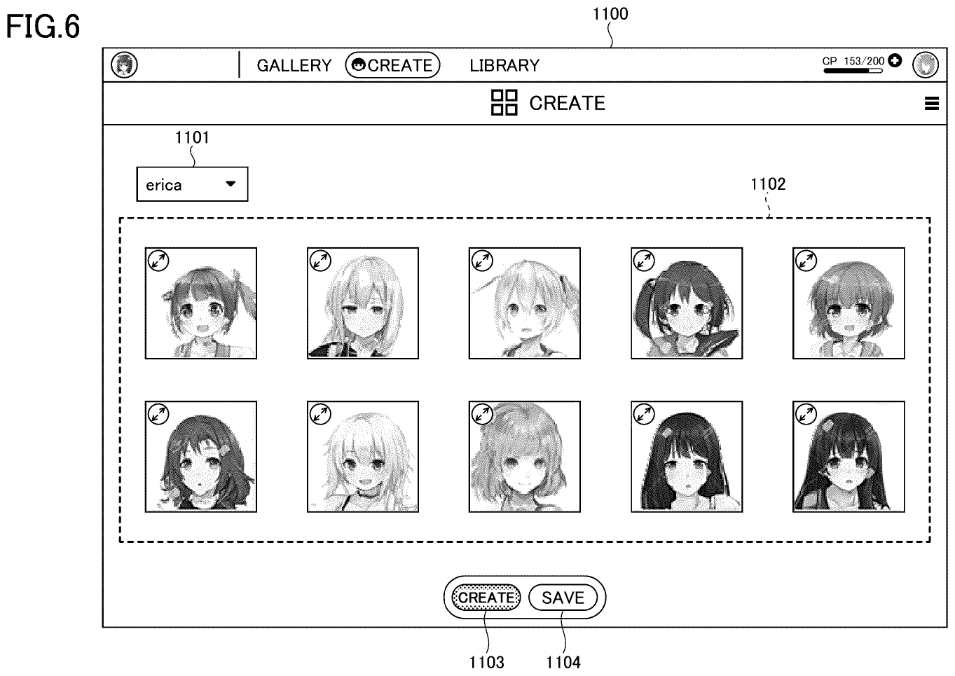

FIG. 6 is a drawing illustrating an example of the image creation screen 1100 after the image is created. As illustrated in FIG. 6, in the image creation screen 1100 after the image is created, the image generated using the generative model selected in the model selection field 1101 is displayed in the image selection area 1102.

The image creation screen 1100 after the image is created illustrated in FIG. 6 is an example of a case where a generative model for processing a face image is selected. For example, when a generative model for processing a whole-body image is selected, the generated whole-body image is displayed in the image selection area 1102. The type of the image is not limited by the image displayed on each screen described below, unless otherwise specified.

The image creation unit 101 may create multiple images and display the images in the image selection area 1102. Additionally, the number of the images to be created can be suitably determined. When multiple images are created, the image creation unit 101 generates multiple random latent variables and inputs each latent variable into the generative model.

Here, when the user presses the creation button 1103 again on the image creation screen 1100 illustrated in FIG. 6, the image creation unit 101 creates an image again, and the image selection area 1102 is updated.

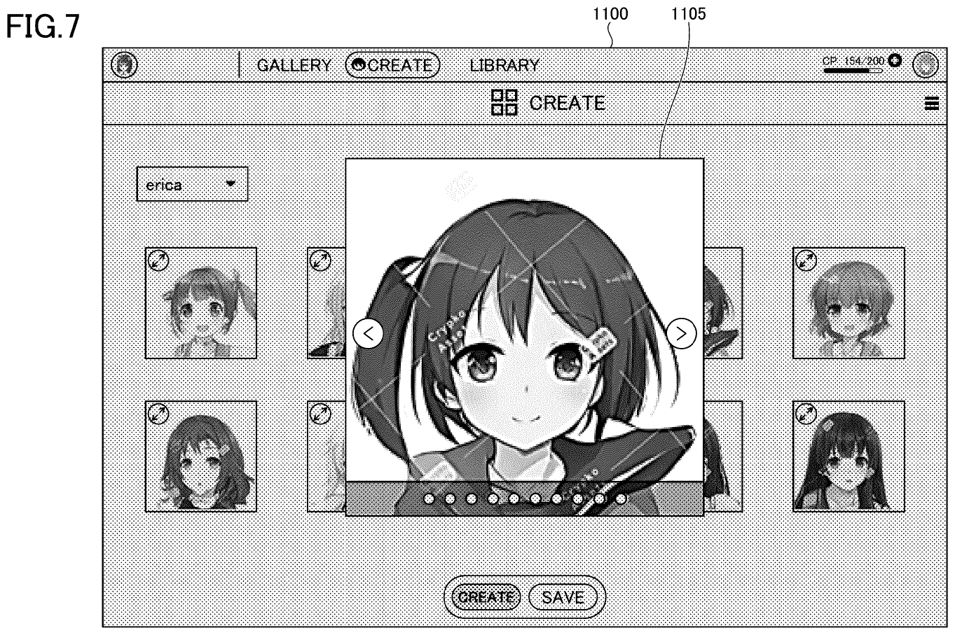

In the image selection area 1102 of the image creation screen 1100, the user can enlarge and display any image. FIG. 7 is a drawing illustrating an example of the image creation screen 1100 in the case where the created image is enlarged and displayed in an enlarged image display area 1105. In FIG. 7, when the user designates the image displayed at the fourth position from the left in the upper row of the image selection area 1102 illustrated in FIG. 6, the image is enlarged and displayed in the enlarged image display area 1105. Here, symbols “<” and “>” may be displayed on the left and right sides of the enlarged image display area 1105. When the user selects the symbol “<”, the image to be displayed in the enlarged image display area 1105 is switched to an image prior to the image enlarged and displayed (in the example of FIG. 7, the third image from the left in the upper row of the image selection area 1102 illustrated in FIG. 6). When the user selects the symbol “>”, the image to be displayed in the enlarged image display area 1105 is switched to an image subsequent to the image enlarged and displayed (in the example of FIG. 7, the fifth image from the left in the upper row of the image selection area 1102 illustrated in FIG. 6).

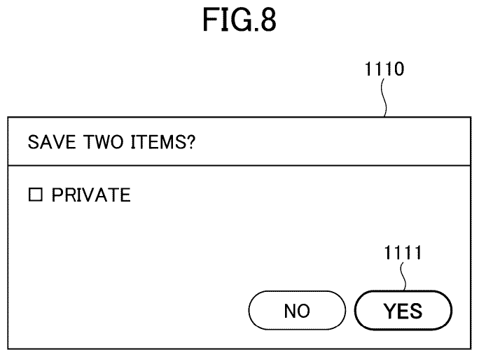

When the user selects any image in the image selection area 1102 of the image creation screen 1100 and presses the save button 1104, a save confirmation screen illustrated in FIG. 8 is displayed. Here, the number of the images that can be selected by the user may be two or more, and the upper limit of the selectable images may be suitably set.

FIG. 8 is a drawing illustrating an example of a save confirmation screen. When the user presses a “YES” button 1111 on a save confirmation screen 1110, the image creation unit 101 stores, in the image information storage unit 120, the image selected in the image selection area 1102, in association with the latent variable of the image and the identification information for identifying the generative model used for the image creation.

### <Image Fusion Processing>

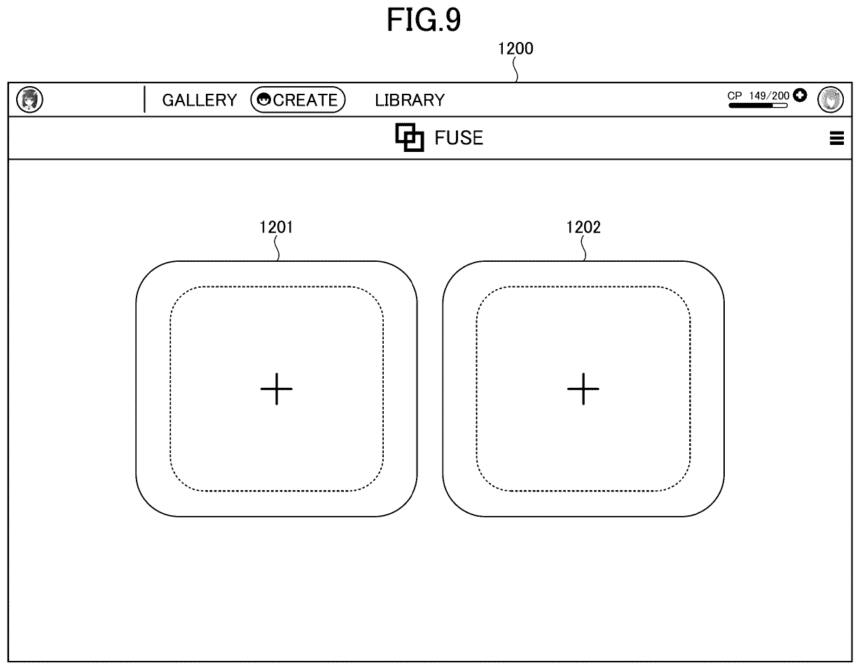

A user interface in the image fusion processing will be described with reference to FIG. 9 to FIG. 12.

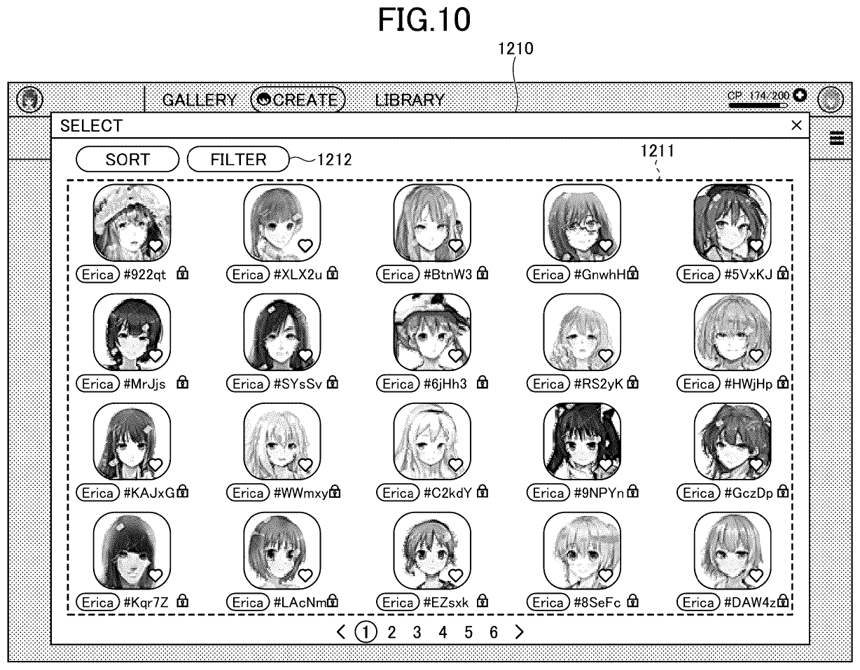

FIG. 9 is a drawing illustrating an example of an image fusion screen for fusing images. As illustrated in FIG. 9, an image fusion screen 1200 includes a first image selection field 1201 and a second image selection field 1202. When the user presses the first image selection field 1201, an image selection screen illustrated in FIG. 10 is displayed.

FIG. 10 is a drawing illustrating an example of the image selection screen. As illustrated in FIG. 10, an image selection screen 1210 includes an image selection area 1211 and a filter button 1212. In the image selection area 1211, the images stored in the image information storage unit 120 are displayed. For each image displayed in the image selection area 1211, the name of the generative model that has generated the image may be displayed together with the image. The user can narrow down the images to be displayed in the image selection area 1211 by performing filter setting via the filter button 1212. An example of the filter is a generative model associated with the image. That is, by designating a generative model in the filter setting, the user can display only the image generated by the generative model.

When the user selects any image (hereinafter, also referred to as a “first image”) in the image selection area 1211 of the image selection screen 1210, the selected first image is displayed in the first image selection field 1201 of the image fusion screen 1200.

Next, when the user presses the second image selection field 1202, the image selection screen 1210 illustrated in FIG. 10 is displayed. When the user selects any image (hereinafter, also referred to as a “second image”) in the image selection area 1211 of the image selection screen 1210, the selected second image is displayed in the second image selection field 1202 of the image fusion screen 1200.

When the second image is selected, the image selection screen 1210 may perform control so that only an image generated by the generative model the same as that of the first image can be selected. For example, the image selection screen 1210 may set the generative model associated with the first image to the filter. As a result, only the image generated by the generative model the same as that of the first image is displayed in the image selection area 1211.

Additionally, for example, when the generative model associated with the second image is different from the generative model associated with the first image, the image selection screen 1210 may display a warning screen indicating that the images cannot be fused and may perform control such that the images cannot be selected. In this case, the user is only required to manually generate a latent variable corresponding to the generative model the same as that of the first image from the second image by using the latent variable generation processing. Additionally, the generated latent variable (corresponding to the generative model the same as that of the first image), the identification information of the generative model the same as that of the first image, and the image generated using both of the generated latent variable and the generative model may be stored in the image information storage unit 120 in association with each other.

Further, the image selection screen 1210 may be configured to allow an image generated by a generative model different from that of the first image to be selected. In this case, the image fusion unit 102 may automatically generate a latent variable corresponding to the generative model the same as that of the first image from the second image by using the latent variable generation processing. Additionally, the generated latent variable (corresponding to the generative model the same as the first image), the identification information of the generative model the same as the first image, and the image generated using both of the generated latent variable and the generative model may be stored in the image information storage unit 120 in association with each other.

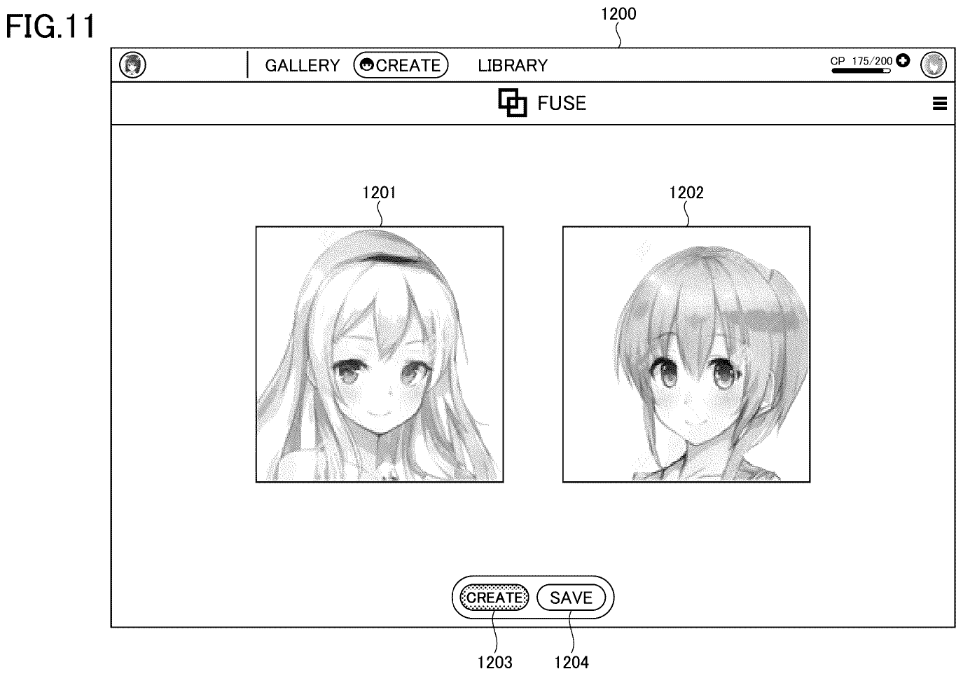

FIG. 11 is a drawing illustrating an example of the image fusion screen after two images are selected. As illustrated in FIG. 11, the image fusion screen 1200 after the images are selected includes the first image selection field 1201, the second image selection field 1202, a creation button 1203, and a save button 1204.

The first image and the second image selected on the image selection screen 1210 are displayed in the first image selection field 1201 and the second image selection field 1202. When the user presses the creation button 1203, the image fusion unit 102 fuses the first image and the second image by using the generative model associated with the first image.

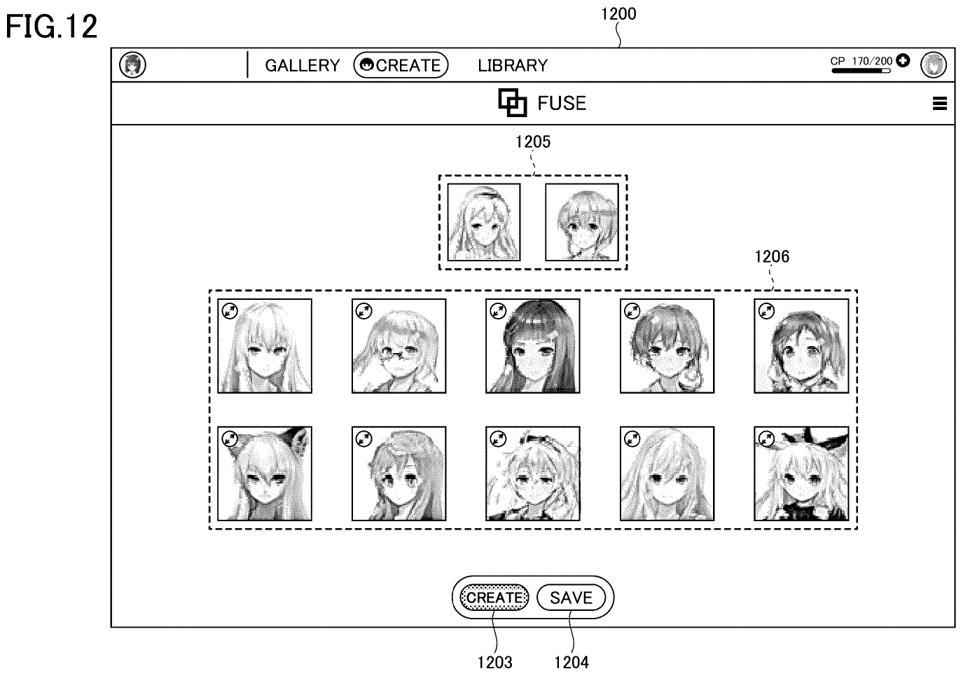

FIG. 12 is a drawing illustrating an example of the image fusion screen 1200 after the images are fused. As illustrated in FIG. 12, the image fusion screen 1200 after the images are fused includes the creation button 1203, the save button 1204, an image display area 1205, and an image selection area 1206.

The first image and the second image before the fusion are displayed in the image display area 1205. A fused image obtained by fusing the first image and the second image is displayed in the image selection area 1206. The fused image may be displayed larger than each of the first image and the second image so that the user can understand the fused image more precisely than the first image and the second image.

The image fusion unit 102 may create multiple fused images and display the fused images in the image selection area 1206, and the number of images to be created can be suitably determined. Here, when the image fusion processing has randomness, the image fusion unit 102 may create multiple fused images by repeatedly performing the image fusion processing multiple times. Additionally, the image fusion unit 102 may create multiple fused images by performing different genetic operations on the latent variable of the first image and the latent variable of the second image.

Here, when the user presses the creation button 1203 again on the image fusion screen 1200 illustrated in FIG. 12, the image fusion unit 102 fuses the images again, and the image selection area 1206 is updated.

When the user selects any fused image in the image selection area 1206 and presses the save button 1204, the save confirmation screen illustrated in FIG. 8 is displayed. Here, the number of images that can be selected by the user may be two or more, and the upper limit of the selectable images may be suitably set.

When the user presses the “YES” button on the save confirmation screen, the image fusion unit 102 stores the fused image selected in the image selection area 1206 in the image information storage unit 120 in association with the latent variable of the fused image and the identification information for identifying the generative model used for the image creation.

### <Attribute Adjustment Processing>

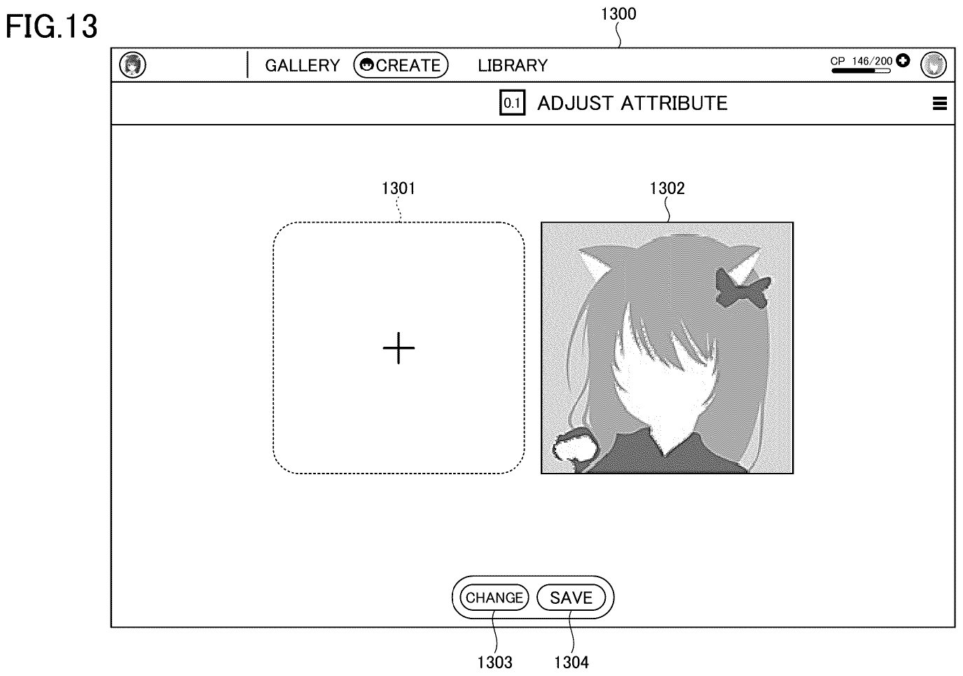

A user interface in the attribute adjustment processing will be described with reference to FIG. 13 to FIG. 15.

FIG. 13 is a drawing illustrating an example of an attribute adjustment screen for adjusting the attribute of the object included in the image. As illustrated in FIG. 13, an attribute adjustment screen 1300 includes an image selection field 1301, a result display field 1302, a change button 1303, and a save button 1304.

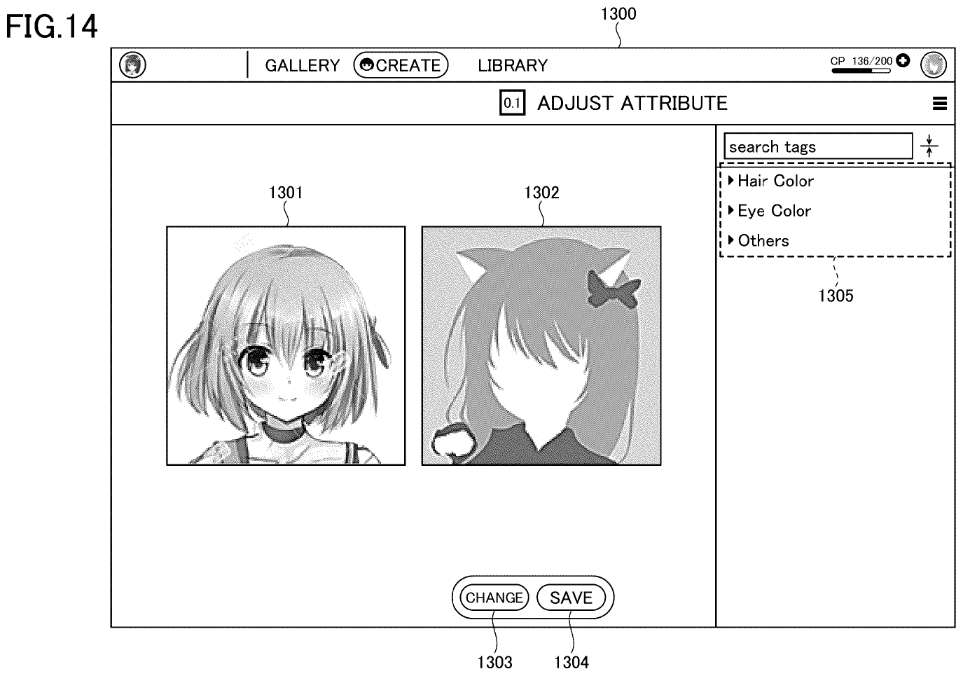

When the user presses the image selection field 1301, the image selection screen illustrated in FIG. 10 is displayed. When the user selects any image (hereinafter, also referred to as a “base image”) in the image selection area of the image selection screen, the attribute adjustment screen illustrated in FIG. 14 is displayed.

FIG. 14 is a drawing illustrating an example of the attribute adjustment screen after the image is selected. As illustrated in FIG. 14, an attribute value designation panel 1305 is displayed on the attribute adjustment screen 1300 after the image is selected. Additionally, the base image is displayed in the image selection field 1301. Adjustable attributes are displayed in the attribute value designation panel 1305. The adjustable attributes may be displayed in a hierarchical structure, and in the example of FIG. 14, the hair color “Hair Color”, the eye color “Eye Color”, and the other attribute “Others” are displayed in a hierarchical structure as the adjustable attributes.

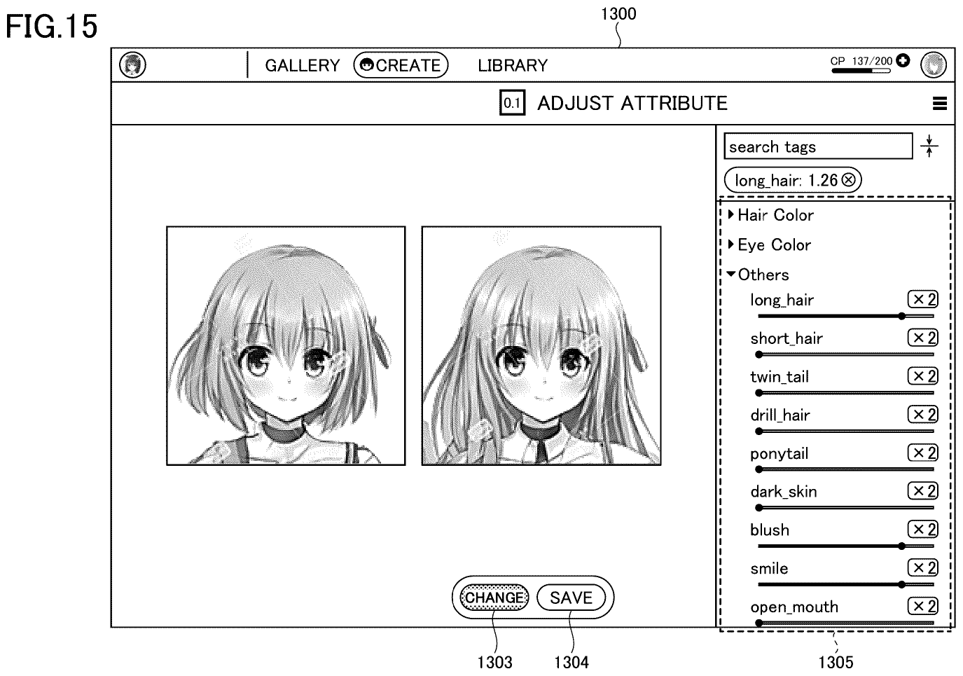

FIG. 15 is a drawing illustrating an example of the attribute adjustment screen after the attribute is adjusted. As illustrated in FIG. 15, in the attribute adjustment screen 1300 after the image is selected, the current value of each attribute is displayed in the attribute value designation panel 1305 such that the value of the attribute can be changed by a slider bar. The user can change any attribute value by the slider bar in the attribute value designation panel 1305. The example of FIG. 15 indicates that the attribute value of the “long_hair” attribute is changed to 1.26. The changed contents (the adjusted attribute and the attribute value thereof) may be displayed in an area on the attribute value designation panel 1305, for example, as the display of “long_hair: 1.26”. Here, as a method of changing the attribute value, in addition to the method of the user operating the slider bar, for example, a method of the user directly inputting a numerical value serving as the attribute value, a method of the user pressing a button for increasing or decreasing the current attribute value by a constant value, or the like may be adopted.

When the user changes any attribute value in the attribute value designation panel 1305 and presses the change button 1303, the attribute adjustment unit 103 converts the latent variable of the base image in accordance with the attribute value designated in the attribute value designation panel 1305. Then, the attribute adjustment unit 103 inputs the converted latent variable into the generative model associated with the image to create an image after the attribute is adjusted. The created image after the attribute is adjusted is displayed in the result display field 1302.

When the user presses the save button 1304, the save confirmation screen illustrated in FIG. 8 is displayed. When the user presses the “YES” button on the save confirmation screen, the attribute adjustment unit 103 stores, in the image information storage unit 120, the image after the attribute is adjusted, displayed in the result display field 1302, in association with the latent variable of the image and the identification information for identifying the generative model used for the image creation.

### <Image Edit Processing>

A user interface in the image edit processing will be described.

An image edit screen includes a segmentation map display field, a result display field, a selection image display field, a reference image display field, an apply button, and an add button. As an example, the segmentation map display field and the result display field may be displayed horizontally side by side near the center of the screen. The selection image display field and the reference image display field may be displayed vertically side by side at the right end of the screen. The segmentation map display field and the result display field may be displayed larger than the selection image display field and the reference image display field. The apply button and the add button may be displayed horizontally side by side at the lower part of the screen.

When the user presses the segmentation map display field, the image selection screen illustrated in FIG. 10 is displayed. When the user selects any image (hereinafter, also referred to as a “base image”) in the image selection area of the image selection screen, a segmentation map of the base image is displayed in the segmentation map display field. Additionally, the base image is displayed in the selection image display field.

The user may select a reference image on the image edit screen. The reference image is an image applied to confirm the edited segmentation map. In this case, the user presses the reference image display field. Then, the image selection screen illustrated in FIG. 10 is displayed. When the user selects any image (hereinafter, also referred to as a “reference image”) in the image selection area of the image selection screen, the reference image is displayed in the reference image display field. Here, when the user presses the apply button, the edited segmentation map displayed in the segmentation map display field is applied to the reference image displayed in the reference image display field, and the result is displayed in the result display field.

Specifically, the image edit unit 104 first predicts a latent variable for each segment from the reference image. Next, the image edit unit 104 converts the latent variable for each segment of the reference image in accordance with the segmentation map displayed in the segmentation map display field.

Subsequently, the image edit unit 104 inputs the converted latent variable for each segment into the edit model corresponding to the generative model associated with the base image to create an edited image. Then, the image edit unit 104 displays the edited image in the result display field.

Here, an operation of editing the image on the image edit screen will be described. The user edits the image by using a tool bar and a layer list displayed on the image edit screen. As an example, the tool bar may be displayed on the left end of the screen, and the layer list may be displayed on the right end of the screen.

The toolbar is a panel for selecting a tool for editing the segmentation map. The layer list is a layer list for selecting a layer of the segmentation map to be edited. The user selects a layer to be edited in the layer list, selects a tool in the tool bar, and edits the selected layer in the segmentation map display field.

When a specific layer is right-clicked in the layer list, a mix ratio designation field is displayed. The mix ratio between the base image and the reference image can be adjusted using the mix ratio designation field.

When the user presses the apply button, the edited segmentation map displayed in the segmentation map display field is applied to the reference image displayed in the reference image display field.

When the user presses the add button, the image edit unit 104 stores, in the image information storage unit 120, the edited image displayed in the result display field in association with the edited segmentation map, the latent variable for each layer of the image, and the identification information for identifying the edit model.

### <Posture Change Processing>

A user interface in the posture change processing will be described.

The posture change screen includes an image selection field, a result display field, a change button, and a save button. As an example, the image selection field may be displayed at the upper left of the screen. The result display field may be displayed near the center of the screen. The result display field may be displayed larger than the image selection field. The change button and the save button may be displayed horizontally side by side at the lower part of the screen.

When the user presses the image selection field, the image selection screen illustrated in FIG. 10 is displayed. When the user selects any image (hereinafter, also referred to as a “base image”) in the image selection area of the image selection screen, the base image is displayed in the image selection field. Additionally, the result display field displays posture information in which articulation points extracted from the base image are connected.

The posture change screen after the image is selected further includes a reference image selection field. When the user presses the reference image selection field, the image selection screen illustrated in FIG. 10 is displayed. When the user selects any image (hereinafter, also referred to as a “reference image”) in the image selection area of the image selection screen, the reference image is displayed in the reference image selection field. At the same time, the posture information displayed in the result display field is updated to the posture information extracted from the reference image displayed in the reference image selection field.

Here, the posture information may be changed by manually moving the articulation point in the result display field without selecting the reference image in the reference image selection field.

When the user presses the change button, the posture change unit 105 converts the latent variable of the image selected in the image selection field in accordance with the posture information displayed in the result display field. Next, the posture change unit 105 creates an image after the posture is changed by inputting the converted latent variable into the generative model associated with the image.

The image after the posture is changed is displayed in the result display field. When the user presses the save button, the posture change unit 105 stores, in the image information storage unit 120, the image displayed in the result display field in association with the latent variable of the image and the identification information for identifying the generative model used for the image creation.

### <Latent Variable Generation Processing>

A user interface in the latent variable generation processing will be described.

The latent variable generation screen includes a model selection field, an image selection field, a result display field, an apply button, and a save button. As an example, the model selection field may be displayed at the upper left of the screen. The image selection field and the result display field may be displayed horizontally side by side near the center of the screen. The apply button and the save button may be displayed horizontally side by side at the lower part of the screen.

In the model selection field, the names of generative models stored in the model storage unit 110 are displayed such that the name of the generative model can be selected in a drop-down list. When the user presses the image selection field, an image selection screen for selecting an image file is displayed. When the user selects an image file on the image selection screen, the selected image file is uploaded to the image processing device 100, and the uploaded image is displayed in the image selection field. When the user selects a generative model in the model selection field and presses the apply button, the latent variable generation unit 106 generates a latent variable from the image displayed in the image selection field by using an encoder model corresponding to the selected generative model. Here, a known technique may be used to generate the latent variable.

When the latent variable generation unit 106 generates the latent variable, an image corresponding to the generated latent variable is displayed in the result display field. Specifically, the latent variable generation unit 106 creates an image by inputting the generated latent variable into the selected generative model. Then, the latent variable generation unit 106 displays the created image in the result display field.

When the user presses the save button, the latent variable generation unit 106 stores, in the image information storage unit 120, the image displayed in the result display field in association with the generated latent variable and identification information for identifying the generative model used for the creation.

### <Point Display>

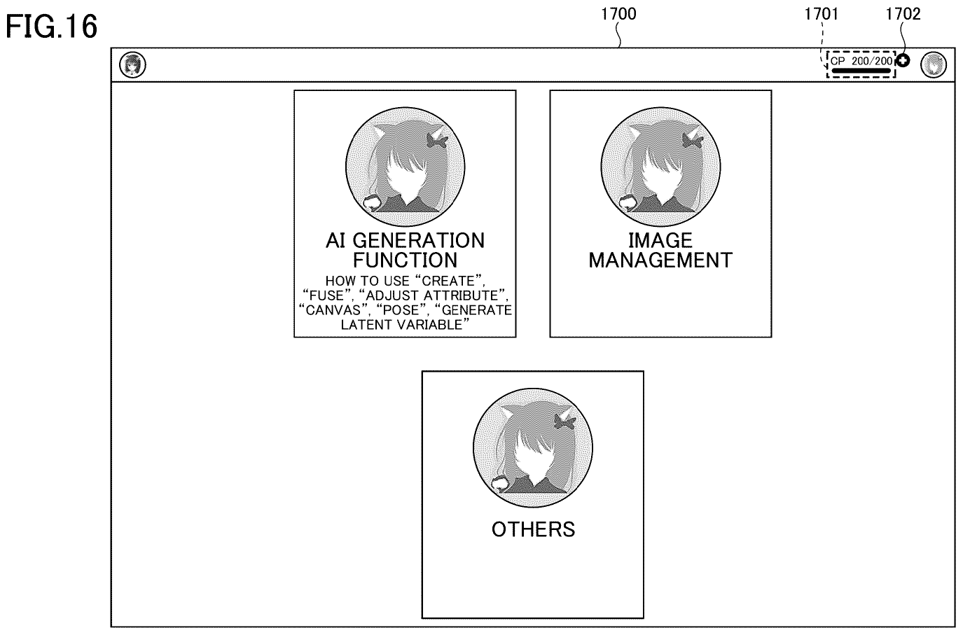

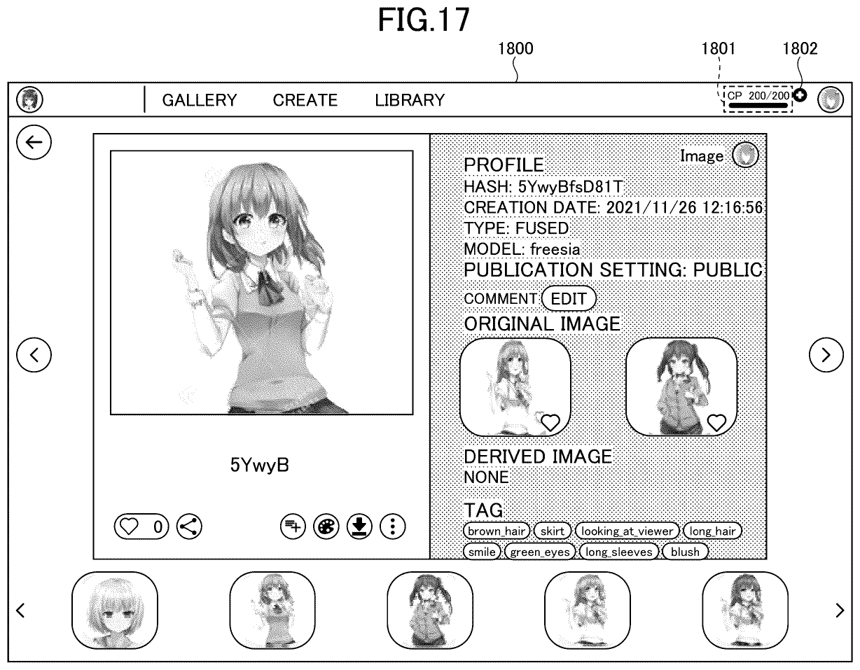

Information on the points possessed by the authenticated user may be displayed on the user interface of the image processing device 100. A display example of the information on the points will be described with reference to FIG. 16 and FIG. 17.

FIG. 16 is a drawing illustrating an example of a help screen for displaying an operation method of the image processing tool. As illustrated in FIG. 16, a help screen 1700 includes a button for displaying the description of each function. Additionally, the help screen 1700 includes a point display field 1701 and a point addition button 1702. The number of the points possessed by the user and the upper limit value of the points that can be possessed by the user are displayed in the point display field 1701. When the user presses the point addition button 1702, a charge screen for purchasing the points is displayed. Here, the point display field 1701 may be displayed on the process selection screen or the screen in each image processing.

FIG. 17 is a drawing illustrating an example of an image detail screen for displaying detailed information on an image. As illustrated in FIG. 17, an image detail screen 1800 displays detailed information, such as a profile, a comment, and a tag of the image. Additionally, the image detail screen 1800 includes a point display field 1801 and a point addition button 1802. The functions of the point display field 1801 and the point addition button 1802 are substantially the same as those of the point display field 1701 and the point addition button 1702 of the help screen 1700.

### [Processing Procedure of Image Processing Method]

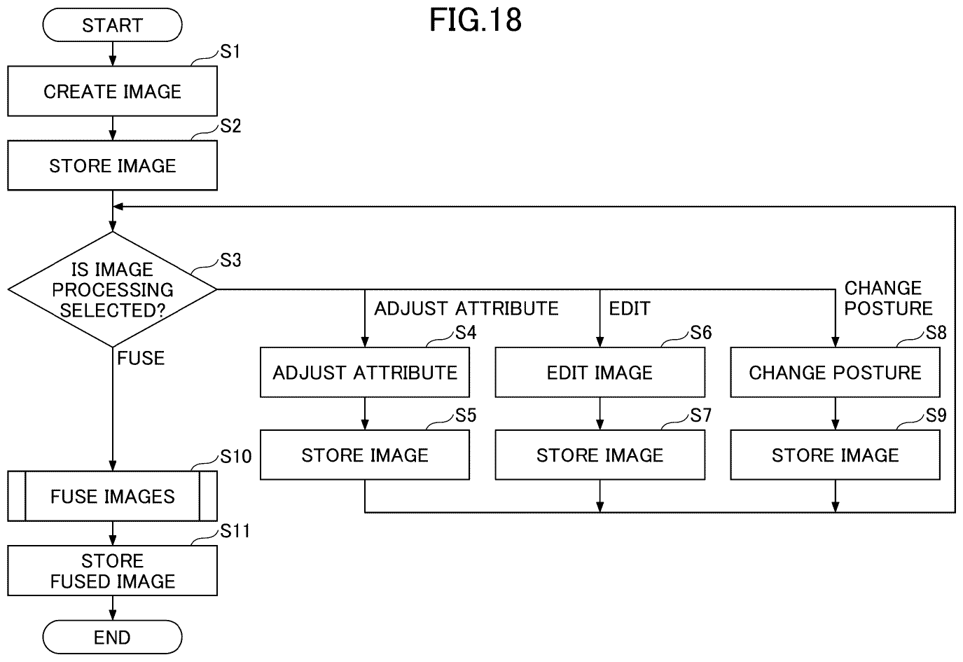

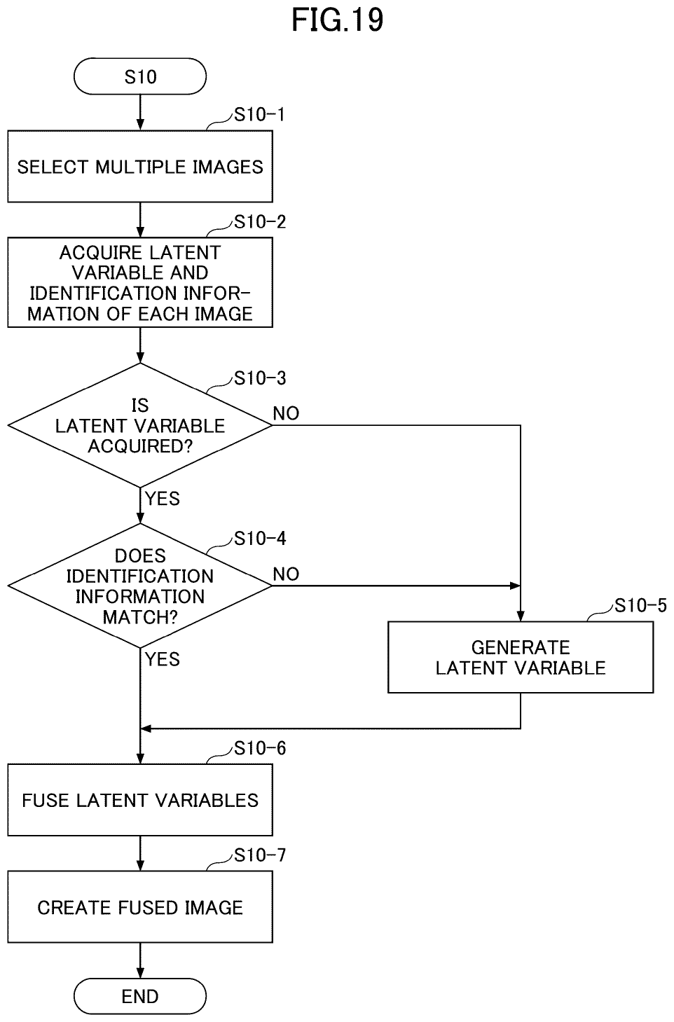

Next, a processing procedure of an image processing method according to the embodiment of the present disclosure will be described with reference to FIG. 18 and FIG. 19. FIG. 18 is a flowchart illustrating an example of the processing procedure of the image processing method.

In step S1, the image creation unit 101 newly creates the image by using the generative model stored in the model storage unit 110 in accordance with a user operation. Next, the point management unit 107 subtracts a predetermined number of points (hereinafter, also referred to as a “first number of points”) from the points possessed by the user.

In step S2, the image creation unit 101 stores the created image in the image information storage unit 120 in association with the latent variable and the identification information of the generative model.

In step S3, the image processing device 100 determines the image processing to be performed next in accordance with a user operation. Specifically, in response to pressing one of the start buttons 1002 to 1005 on the process selection screen 1000 illustrated in FIG. 2 or 3, the image processing corresponding to the start button is performed.

When the start button 1003 (attribute adjustment processing) is pressed, the image processing device 100 advances the process to step S4. When the start button 1004 (image edit processing) is pressed, the image processing device 100 advances the process to step S6. When the start button 1005 (posture change processing) is pressed, the image processing device 100 advances the process to step S8. When the start button 1002 (image fusion processing) is pressed, the image processing device 100 advances the process to step S10.

In step S4, the attribute adjustment unit 103 adjusts the attribute of the object included in the image by using the generative model stored in the model storage unit 110 in accordance with a user operation. Next, the point management unit 107 subtracts a predetermined number of points (hereinafter, referred to as a “second number of points”) from the points possessed by the user. The second number of points is set to be less than the first number of points.

In step S5, the attribute adjustment unit 103 stores, in the image information storage unit 120, the image whose attribute has been adjusted in association with the converted latent variable and the identification information of the generative model.

In step S6, the image edit unit 104 edits the image by using the edit model stored in the model storage unit 110 in accordance with a user operation. Next, the point management unit 107 subtracts the second number of points from the points possessed by the user.

In step S7, the image edit unit 104 stores the edited image in the image information storage unit 120 in association with the converted latent variable and the identification information of the edit model used for the image editing.

In step S8, the posture change unit 105 changes the posture of the object included in the image by using the generative model stored in the model storage unit 110 in accordance with a user operation. Next, the point management unit 107 subtracts the second number of points from the points possessed by the user.

In step S9, the posture change unit 105 stores, in the image information storage unit 120, the image whose posture has been changed, in association with the converted latent variable and the identification information of the generative model.

In step S10, the image fusion unit 102 fuses at least two images by using the generative model stored in the model storage unit 110 in accordance with a user operation. Next, the point management unit 107 subtracts the first number of points from the points possessed by the user.

In step S11, the image fusion unit 102 stores the created fused image in the image information storage unit 120 in association with the fused latent variable and the identification information of the generative model.

### <Processing Procedure of Image Fusion Processing>

A detailed procedure of the image fusion processing (step S10 of FIG. 18) in the embodiment of the present disclosure will be described with reference to FIG. 19. FIG. 19 is a flowchart illustrating an example of a processing procedure of the image fusion processing.

In step S10-1, the image fusion unit 102 receives selection of multiple images in accordance with a user operation. The multiple images to be selected may be the images stored in the image information storage unit 120 or the images uploaded by the user. When all of the selected images are the images stored in the image information storage unit 120, the generative models that have generated the images may be the same or different.

In step S10-2, the image fusion unit 102 acquires the latent variable stored in the image information storage unit 120 and the identification information for identifying the generative model, for each of the received images. Here, when the received image is uploaded by the user, the latent variable and the identification information of the generative model cannot be acquired, but the subsequent processing is performed as it is.

In step S10-3, the image fusion unit 102 determines whether the latent variable of each image has been acquired. If the latent variables of all the images have been acquired (YES), the image fusion unit 102 advances the process to step S10-4. If the latent variable of any image cannot be acquired (NO), the image fusion unit 102 transmits, to the latent variable generation unit 106, one image for which the latent variable cannot be acquired and the identification information of the generative model of the other image for which the latent information can be acquired, and advances the process to step S10-5.

In step S10-4, the image fusion unit 102 determines whether the identification information of the generative models of the images is identical. If the identification information of the generative models of all the images is identical (YES), the image fusion unit 102 advances the process to step S10-6. If the identification information of the generative model of any one of the images is different (NO), the image fusion unit 102 transmits, to the latent variable generation unit 106, the one image having different identification information and the identification information of the generative model of the other image, and advances the process to step S10-5.

In step S10-5, the latent variable generation unit 106 identifies the generative model by the identification information received from the image fusion unit 102, and determines the encoder model corresponding to the generative model. Next, the latent variable generation unit 106 generates the latent variable by inputting the image received from the image fusion unit 102 into the identified encoder model. As described above, the generative model may be used to generate the latent variable.

In step S10-6, the image fusion unit 102 generates a fused latent variable by fusing the latent variables of the selected images. However, when the latent variable is generated in step S10-5, the latent variable of the other image and the generated latent variable are fused.

In step S10-7, the image fusion unit 102 creates a fused image by inputting the fused latent variable into the generative model. The generative model is a generative model identified by the identification information of the generative model of each image.

### [Supplement]

Although, in the above description, the image, the latent variable, and the identification information of the generative model are stored in association with each other when the result of each image processing described above is stored, the latent variable and the identification information of the generative model may be stored in association with each other. The corresponding image may be created again from the latent variable and the generative model when necessary, for example, when a display request is received.

“storing the latent variable in association with the identification information of the generative model” includes both a case of storing the latent variable in direct association and a case of storing the latent variable in indirect association. For example, the latent variable and the identification information of the generative model may be stored as set data, or the identification information of the generative model may be assigned to the latent variable and stored. Additionally, for example, “the latent variable and the identification information of the image (the name of the image, the ID of the image, or the like) may be linked and stored, and the identification information of the generative model and the identification information of the same image may be linked and stored”. In this case, based on the identification information of the image, the latent variable and the identification information of the generative model corresponding thereto can be called. Additionally, the latent variable and the generative model themselves may be stored as a set. Any method may be used as long as the method can call the correspondence relationship between the “latent variable” and the “generative model corresponding thereto” in the subsequent processing.

The user interfaces illustrated in FIG. 2 to FIG. 17 may be displayed on a terminal (for example, a PC, a smartphone, or the like) directly operated by the user.

The user information storage unit 130 may store a set of the identification information of the user and the identification information of the image owned by the user. In this case, in each image processing, the restriction may be applied such that only the image associated with the user is called as the processing target.

### SUMMARY

According to the present embodiment, a device that enables various image processing to be performed can be provided. Additionally, by using the image processing device 100 according to the present embodiment, a service that enables various image processing to be performed can be provided.

The image processing device 100 according to the present embodiment stores the latent variable of the image in association with the identification information for identifying the generative model, thereby enabling the image to be shared among various image processing. In the image fusion processing, multiple images to be fused are required to belong to the latent space of the same generative model or be linked with the same generative model. Thus, by associating the latent variables of the images with the identification information of the generative model as in the present embodiment, appropriate image fusion processing can be performed. Additionally, in other image processing(s), by using the generative model associated with the latent variable, appropriate image processing can be performed. Additionally, in the image fusion processing, when multiple images to be fused are created using different generative models, the latent variable corresponding to the same generative model can be generated by performing the latent variable generation processing.

When performing the image fusion processing, the image processing device 100 according to the present embodiment can select images to be fused from the images filtered based on the generative model. With this, the fusion processing can be performed using multiple latent variables corresponding to the same generative model.

The image processing device 100 according to the present embodiment can increase the user's motivation for the image processing tool by setting the consumption points according to the image processing. As a result, it is possible to cause the user to consume more points.

When performing the image creation processing, the image processing device 100 according to the present embodiment stores, for example, the identification information of the image, the latent variable, the identification information of the corresponding generative model, and the created image. At this time, it can be suitably determined whether to store the identification information of the image and the created image.

When performing the image fusion processing, the image processing device 100 according to the present embodiment stores, for example, the identification information of the image, the fused latent variable, the identification information of the corresponding generative model, the created fused image, and the identification information of two images used for the fusion. At this time, it can be suitably determined whether to store the identification information of the image, the created fused image, and the identification information of the two images used for the fusion. When the identification information of the image used for the fusion is stored, the latent variable of the original image and the identification information of the generative model can be acquired from the identification information of the image.

When performing the attribute adjustment processing, the image processing device 100 according to the present embodiment stores, for example, the identification information of the image, the latent variable after the attribute adjustment, the identification information of the corresponding generative model, and the identification information of the image created after the attribute adjustment, and the identification information of the image before the attribute adjustment. At this time, it can be suitably determined whether to store the identification information of the image, the image created after the attribute adjustment, and the identification information of the image before the attribute adjustment. When the identification information of the image before the attribute adjustment is stored, the latent variable of the image before the attribute adjustment and the identification information of the generative model can be acquired from the identification information of the image before the attribute adjustment.

When performing the posture change processing, the image processing device 100 according to the present embodiment stores, for example, the identification information of the image, the latent variable after the posture change, the identification information of the corresponding generative model, and the identification information of the image created after the posture change, and the identification information of the image before the posture change. At this time, it can be suitably determined whether to store the identification information of the image, the image created after the posture change, and the identification information of the image before the posture change. When the identification information of the image before the posture change is stored, the latent variable of the image before the posture change and the identification information of the generative model can be acquired from the identification information of the image before the posture change.

When performing the latent variable generation processing, the image processing device 100 according to the present embodiment stores, for example, the identification information of the image, the generated latent variable, the identification information of the corresponding generative model, the image created by inputting the generated latent variable into the corresponding generative model, the original image used to generate the latent variable, and the identification information of the encoder model used to generate the latent variable. At this time, it can be suitably determined whether to store the image created by inputting the generated latent variable into the corresponding generative model, the original image used to generate the latent variable, and the identification information of the encoder model used to generate the latent variable.

When performing the image edit processing, the image processing device 100 according to the present embodiment stores, for example, the identification information of the image, the latent variable after the editing, the identification information of the corresponding edit model, the segmentation map, the image after the editing, and the identification information of the image before the editing. At this time, it can be suitably determined whether to store the identification information of the image, the segmentation map, the image after the editing, and the identification information of the image before the editing. When the identification information of the image before the editing is stored, the latent variable and the identification information of the generative model of the image before the editing can be acquired from the identification information of the image before the editing.

After performing the image creation processing, the image processing device 100 according to the present embodiment may perform the attribute adjustment processing, the posture change processing, and the image fusion processing by using the stored latent variable and the corresponding generative model.

After performing the image fusion processing, the image processing device 100 according to the present embodiment may perform the attribute adjustment processing, the posture change processing, and the image fusion processing (that is, repetition of the same image processing) by using the stored latent variable and the corresponding generative model.

After performing the attribute adjustment processing, the image processing device 100 according to the present embodiment may perform the posture changing processing, the image fusion processing, and the attribute adjustment processing (that is, repetition of the same image processing) by using the stored latent variable and the corresponding generative model.

After performing the posture change processing, the image processing device 100 according to the present embodiment may perform the attribute adjustment processing, the image fusion processing, and the posture change processing (that is, repetition of the same image processing) by using the stored latent variable and the corresponding generative model.

The latent variable generation processing may be performed in the following timing. The first timing is a timing when detecting that the generative models used for the creation are different between the images to be fused. The second timing is before the attribute adjustment processing, the posture change processing, and the image fusion processing are performed on an image for which a latent variable is not present, such as a user-designated image.

In each image processing, the processing may be performed using the “latent variable” and the “generative model” determined by the identification information of the generative model stored in association with the “latent variable”. At least in the image creation processing, the image fusion processing, the attribute adjustment processing, and the posture change processing, the processing may be performed using the same generative model and the latent variable corresponding thereto.

Additionally, in the latent variable generation processing, the latent variable may be generated using the same generative model. The image processing device 100 according to the present embodiment may include one or more storage devices and one or more processors. In this case, the one or more processors can control to store various data in the one or more storage devices and acquire various data from the one or more storage devices. Additionally, the one or more processors may control a screen displayed on the display device.

### [Hardware Configuration of Image Processing Device]

A part or the whole of the device in the above-described embodiments (the image processing device 100) may be configured by hardware, or may be configured by information processing of software (a program) performed by a central processing unit (CPU), a graphics processing unit (GPU), or the like. In the case where the embodiment is configured by the information processing of software, software implementing at least a part of the functions of each device in the above-described embodiment may be stored in a non-temporary storage medium (a non-temporary computer-readable medium) such as a compact disc-read only memory (CD-ROM) or a universal serial bus (USB) memory, and may be read into a computer to perform the information processing of software. The software may be downloaded via a communication network. Further, all or a part of the processing of software may be implemented in a circuit such as an application specific integrated circuit (ASIC) or a field programmable gate array (FPGA), so that information processing by the software may be performed by hardware.

The storage medium storing software may be a detachable storage medium such as an optical disk or a fixed storage medium such as a hard disk drive or a memory. Additionally, the storage medium may be provided inside the computer (a main storage device, an auxiliary storage device, and the like) or outside the computer.

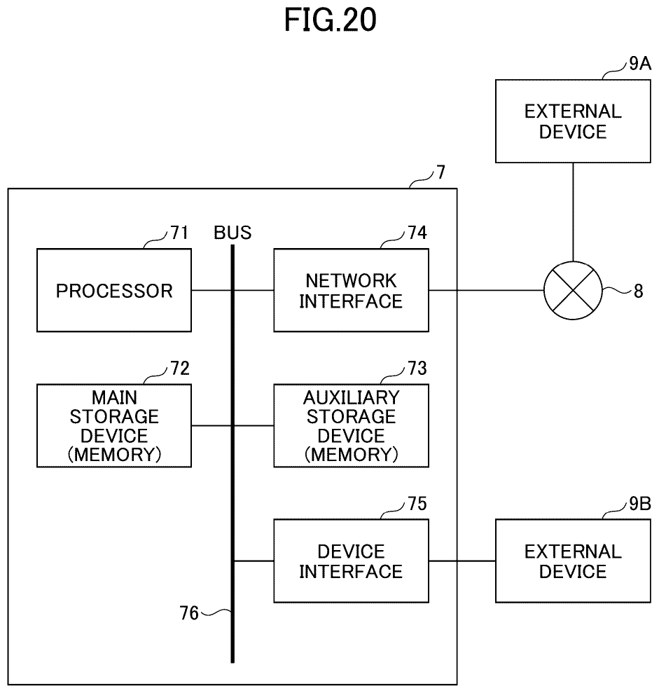

FIG. 20 is a block diagram illustrating an example of a hardware configuration of the device in the above-described embodiments (the image processing device 100). The device may be implemented as a computer 7 including a processor 71, a main storage device 72 (memory), an auxiliary storage device 73 (memory), a network interface 74, and a device interface 75, which are connected via a bus 76, for example.

The computer 7 of FIG. 20 includes one of each component, but may include multiple units of the same components. Additionally, although FIG. 20 illustrates one computer 7, software may be installed in multiple computers, and the multiple computers may perform the same or different part of processing of the software. In this case, the computers may be in the form of distributed computing that performs processing by the computers communicating with each other via the network interface 74 or the like. That is, the device (the image processing device 100) in the above-described embodiments may be configured as a system that realizes a function by causing one or more computers to execute instructions stored in one or more storage devices. Additionally, information transmitted from a terminal may be processed by one or more computers provided on the cloud, and the processing result may be transmitted to the terminal.

Various operations of the device (the image processing device 100) in the above-described embodiments may be performed in parallel by using one or multiple processors or using multiple computers connected via a network. Additionally, various operations may be distributed to multiple cores in the processor and may be performed in parallel. Additionally, some or all of the processes, means, and the like of the present disclosure may be implemented by at least one of a processor or a storage device provided on a cloud that can communicate with the computer 7 via a network. As described above, the device in the above-described embodiments may be in a form of parallel computing by one or more computers.

The processor 71 may be an electronic circuit (a processing circuit, processing circuitry, a CPU, a GPU, an FPGA, an ASIC, or the like) that performs at least one of computer control or operations. Additionally, the processor 71 may be any of a general-purpose processor, a dedicated processing circuit designed to execute a specific operation, and a semiconductor device including both a general-purpose processor and a dedicated processing circuit. Additionally, the processor 71 may include an optical circuit or may include an arithmetic function based on quantum computing.

The processor 71 may perform arithmetic processing based on data or software input from each device or the like of the internal configuration of the computer 7, and may output an arithmetic result or a control signal to each device or the like. The processor 71 may control respective components constituting the computer 7 by executing an operating system (OS), an application, or the like of the computer 7.

The device (the image processing device 100) in the above-described embodiments may be implemented by one or multiple processors 71. Here, the processor 71 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 72 may store instructions executed by the processor 71, various data, and the like, and information stored in the main storage device 72 may be read by the processor 71. The auxiliary storage device 73 is a storage device other than the main storage device 72. Here, these storage devices indicate any electronic components capable of storing electronic information, and may be semiconductor memories. The semiconductor memory may be either a volatile memory or a nonvolatile memory. The storage device for storing various data and the like in the device in the above-described embodiments (the image processing device 100) may be realized by the main storage device 72 or the auxiliary storage device 73, or may be realized by a built-in memory built in the processor 71. For example, the model storage unit 110, the image information storage unit 120, and the user information storage unit 130 in the above-described embodiments may be realized by the main storage device 72 or the auxiliary storage device 73.

When the device in the above-described embodiments (the image processing device 100) includes at least one storage device (memory) and at least one processor connected (coupled) to the at least one storage device, the at least one processor may be connected to one storage device. Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 74 is an interface for connecting to a communication network 8 by wire or wirelessly. As the network interface 74, an appropriate interface, such as one conforming to an existing communication standard, may be used. The network interface 74 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 75 is an interface, such as a USB, that is directly connected to an external device 9B.

The external device 9A is a device connected to the computer 7 via a network 8. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as an HDD.

Additionally, the external device 9A or the external device 9B may be a device having a function of a part of the components of the device in the above-described embodiments (the image processing device 100). That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if a term such as “maximize” or “maximization” is used, it should be interpreted as appropriate according to a context in which the term is used, including obtaining a global maximum value, obtaining an approximate global maximum value, obtaining a local maximum value, and obtaining an approximate local maximum value. It also includes obtaining approximate values of these maximum values, stochastically or heuristically. Similarly, if a term such as “minimize” or “minimization” is used, it should be interpreted as appropriate, according to a context in which the term is used, including obtaining a global minimum value, obtaining an approximate global minimum value, obtaining a local minimum value, and obtaining an approximate local minimum value. It also includes obtaining approximate values of these minimum values, stochastically or heuristically. Similarly, if a term such as “optimize” or “optimization” is used, the term should be interpreted as appropriate, according to a context in which the term is used, including obtaining a global optimum value, obtaining an approximate global optimum value, obtaining a local optimum value, and obtaining an approximate local optimum value. It also includes obtaining approximate values of these optimum values, stochastically or heuristically.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

What is claimed is:

1. An image processing device comprising:
one or more storage devices; and
one or more processors,
wherein the one or more processors are configured to:
create a first image by inputting a first latent variable into a first generative model;
store the first latent variable in the one or more storage devices in association with identification information of the first generative model;
acquire the first latent variable and the identification information of the first generative model associated with the first latent variable from the one or more storage devices;
generate a second latent variable based on the first latent variable;
create a second image by inputting the second latent variable into the first generative model; and
store the second latent variable in the one or more storage devices in association with the identification information of the first generative model, and
wherein the second image is different from the first image and includes at least a second object different from a first object included in the first image.

2. The image processing device as claimed in claim 1, wherein the second object is obtained by changing at least one of an attribute or a posture of the first object.

3. The image processing device as claimed in claim 1,
wherein the one or more processors generate the second latent variable by fusing the first latent variable and a third latent variable, and
wherein the first object and a third object included in a third image are fused in the second object, the third image being generated by inputting the third latent variable into the first generative model, and
wherein the third latent variable is stored in the one or more storage devices in association with the first generative model.

4. The image processing device as claimed in claim 1, wherein the one or more processors are further configured to generate the first latent variable by using another image different from the first image.

5. The image processing device as claimed in claim 4, wherein the one or more processors generate the first latent variable by using at least one of an encoder model or the first generative model, and the another image.

6. The image processing device as claimed in claim 1,
wherein the one or more processors are further configured to generate the first latent variable by fusing a fourth latent variable and a fifth latent variable,
wherein a fourth object included in a fourth image and a fifth object included in a fifth image are fused in the first object, the fourth image being generated by inputting the fourth latent variable into the first generative model, and the fifth image being generated by inputting the fifth latent variable into the first generative model,
wherein the fourth latent variable is stored in the one or more storage devices in association with the first generative model, and
wherein the fifth latent variable is stored in the one or more storage devices in association with the first generative model.

7. The image processing device as claimed in claim 1,
wherein the one or more storage devices store at least the first generative model and a second generative model, and
wherein the one or more processors perform image processing by using the first generative model based on an instruction of a user.

8. An image processing device comprising:
one or more storage devices; and
one or more processors,
wherein the one or more processors are configured to:
display, on a display device, a process selection screen on which at least a start of first image processing and a start of second image processing are selectable;
start the first image processing based on an instruction of a user and create a first image by using a first generative model;
store, in the one or more storage devices, a first latent variable used to create the first image in association with the first generative model, based on an instruction of the user;
start the second image processing based on an instruction of the user and create a second image by using the first generative model; and
store, in the one or more storage devices, a second latent variable used to create the second image in association with the first generative model, based on an instruction of the user,
wherein the second latent variable is generated based on the first latent variable, and
wherein the first image processing and the second image processing are different.

9. The image processing device as claimed in claim 8, wherein the first image processing and the second image processing are any of image creation processing, image fusion processing, attribute adjustment processing, posture change processing, and latent variable generation processing.

10. The image processing device as claimed in claim 9,
wherein the first image processing is the image creation processing, and
wherein a start button for the first image processing is displayed at a leftmost and uppermost position in the process selection screen, in comparison with a start button for another image processing.

11. The image processing device as claimed in claim 9,
wherein the second image processing is one of attribute adjustment processing or posture change processing,
wherein the one or more storage devices further store identification information of the user and points given to the user in association with each other, and
wherein the one or more processors are configured to subtract a predetermined number of points from the points in a case where at least one of the second image or the second latent variable is stored in the one or more storage devices based on an instruction of the user.

12. The image processing device as claimed in claim 9,
wherein the first image processing is one of the image creation processing or the image fusion processing,
wherein the second image processing is one of the attribute adjustment processing or the posture change processing,
wherein the one or more storage devices further store identification information of the user and points given to the user in association with each other,
wherein the one or more processors are configured to:
subtract a predetermined number of points from the points in response to the first image being generated; and
subtracting a predetermined number of points from the points in response to the second image being generated, and
wherein the predetermined number of points subtracted in response to the second image being generated is less than the predetermined number of points subtracted in response to the first image being generated.

13. The image processing device as claimed in claim 12, wherein the predetermined number of points subtracted in response to the second image being generated is 0.

14. The image processing device as claimed in claim 9,
wherein the first image processing is one of the image creation processing, the attribute adjustment processing, the posture change processing, or the latent variable generation processing,
wherein the second image processing is the image fusion processing,
wherein the one or more storage devices further store identification information of the user and points given to the user in association with each other,
wherein the one or more processors are configured to:
subtract a predetermined number of points from the points in response to the first image being generated; and
subtract a predetermined number of points from the points in response to the second image being generated, and
wherein the predetermined number of points subtracted in response to the first image being generated is less than the predetermined number of points subtracted in response to the second image being generated.

15. The image processing device as claimed in claim 14, wherein the predetermined number of points subtracted in response to the first image being generated is 0.

16. An image processing device comprising:
one or more storage devices; and
one or more processors,
wherein the one or more processors are configured to:
select a first image based on an instruction of a user;
display, on a display device, a plurality of images generated by using a generative model that is same as a generative model of the first image;
select a second image from among the plurality of images based on an instruction of the user;
fuse a latent variable of the first image and a latent variable of the second image to generate a fused latent variable;
input the fused latent variable into the generative model to generate a fused image; and
store the fused latent variable in the one or more storage devices in association with identification information of the generative model.

17. An image processing method comprising:
displaying, by one or more processors, on a display device, a process selection screen on which at least a start of first image processing and a start of second image processing are selectable;
starting, by the one or more processors, the first image processing based on an instruction of a user and creating a first image by using a first generative model;
storing, by the one or more processors, in one or more storage devices, a first latent variable used to create the first image in association with the first generative model, based on an instruction of the user;
starting, by the one or more processors, the second image processing based on an instruction of the user and creating a second image by using the first generative model; and
storing, by the one or more processors, in the one or more storage devices, a second latent variable used to create the second image in association with the first generative model based on an instruction of the user,
wherein the second latent variable is generated based on the first latent variable, and
wherein the first image processing and the second image processing are different.

18. The image processing device as claimed in claim 1, wherein the first latent variable includes at least one of a value sampled from a probability distribution, code information, attribute information, noise, gene information, or posture information.

19. The image processing device as claimed in claim 8, wherein the first latent variable includes at least one of a value sampled from a probability distribution, code information, attribute information, noise, gene information, or posture information.

20. The image processing device as claimed in claim 16, wherein the latent variable of the first image includes at least one of a value sampled from a probability distribution, code information, attribute information, noise, gene information, or posture information.
